(19) United States
(12) Patent Application Publication
(10) Pub. No.: US 2008/0158591 A1
(43) Pub. Date: Jul. 3, 2008

(54) IMAGE PROCESSING APPARATUS AND CONTROL METHOD THEREOF

(75) Inventor: Ju-ho EUM, Anyang-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/958,594

(22) Filed: Dec. 18, 2007

(30) Foreign Application Priority Data
Dec. 28, 2006 (KR) 2006-136617

(51) Int. Cl. G06K 1/00

(52) U.S. Cl. 358/1.15

(57) ABSTRACT

An image processing method and apparatus receives a web page which has a motion image including a plurality of still images from a web server, selects a printing option of the motion image included in the received web page according to a user's command, and generates printing data according to the selected printing option.

### CROSS-REFERENCE TO RELATED APPLICATIONS

This application claims priority under 35 U.S.C. §119(a) from Korean Patent Application No. 10-2006-0136617, filed on Dec. 28, 2006, in the Korean Intellectual Property Office, the disclosure of which is incorporated herein by reference in its entirety.

### BACKGROUND OF THE INVENTION

1. Field of the Invention

The present general inventive concept relates to an image processing apparatus and an image processing method, and more particularly, to an image processing apparatus which generates printing data of a web page having a motion image, and an image processing method thereof.

2. Description of the Related Art

An image processing apparatus such as a computer system is a host apparatus of a printing device such as a printer and a multifunction printer, and generates printing data to be transmitted to the printing device and to be printed on a printing medium such as a printing paper.

The image processing apparatus is connected to a web server providing a web page, and receives the web page therefrom to display it, and generates printing data to print the displayed web page.

The web page may include a still image or a motion image as well as texts. The motion image includes a plurality of still images that are sequentially displayed. For example, the motion image may include an image of adobe flash (hereinafter, to be called “flash image”).

If the web page having the motion image is printed, a conventional image processing apparatus prints a predetermined still image or a still image displayed when a user commands to print the web page, among the plurality of still images.

If a user wants to print other still images than the printed still image, the conventional image processing apparatus may not meet a user's demand. Thus, a user may not print a desired image, or may repeatedly print the web page until the user receives the desired still image. It may waste a lot of printing papers accordingly.

### SUMMARY OF THE INVENTION

The present general inventive concept provides an image processing apparatus which prints a desired image of a web page having a motion image and meets a user's demand, and an image processing method thereof.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an image processing method, comprising receiving a web page which has a motion image including a plurality of still images from a web server, selecting a printing option of the motion image included in the received web page according to a user's command, and generating printing data according to the selected printing option.

The selecting the printing option of the motion image may comprise receiving the motion image from the web server, and playing the received motion image and selecting at least one still image from the motion image being played.

The generating the printing data may include generating the printing data of the web page, and modifying the printing data of the web page to replace a motion image part of the generated printing data in the web page with the selected still image.

The generating the printing data may comprise generating printing data obtained by adding the still image to the web page according to the selected printing option.

The printing data may comprise the selected still image whose size or position is changeable.

The printing data may comprise at least two selected still images.

Information on the motion image may be printable instead of the still image.

The image processing method may further comprise displaying an image corresponding to the printing data generated according to the printing option by a user interface of a printing device driver.

The foregoing and/or other aspects and utilities of the present general inventive concept may also be achieved by providing an image processing apparatus comprising a communicating part which communicates with a web server providing a web page having a motion image including a plurality of still images, an image processor which generates printing data of the still image, and a controller which controls the image processor to generate the printing data according to a printing option of the motion image selected by a user's command.

The apparatus may further comprise a motion image player which plays a motion image file, wherein the controller controls the motion image player to play the received motion image and select at least one still image from the motion image being played.

The controller may control the image processor to generate printing data of the web page and modify the generated printing data of the generated web page by replacing a motion image part of the generated printing data in the generated web page with the selected still image.

The controller may control the image processor to generate printing data obtained by adding the still image to the web page according to the selected printing option.

The printing data may comprise the selected still image whose size or position is changeable.

The printing data may comprise at least two selected still images.

Information on the motion image may be printable instead of the still image.

The controller may control a display part to display an image corresponding to the printing data generated according to the printing option by a user interface of a printing device driver.

The foregoing and/or other aspects and utilities of the present general inventive concept may also be achieved by providing a computer readable medium to contain computer-readable codes as a program to execute an image processing method in an image processing apparatus, the method including receiving a web page which has a motion image including a plurality of still images from a web server, selecting a printing option of the motion image included in the received web page according to a user's command, and generating printing data according to the selected printing option.

The foregoing and/or other aspects and utilities of the present general inventive concept may also be achieved by providing an image processing apparatus, including a communicating part which communicates with a web server to receive a motion image represented by a plurality of still images, and an image processor which generates print data to correspond to at least one of the plurality of still images according to a printing option of the at least one still image.

The apparatus may further include an input part to select the at least one still image from the plurality of still images, and to generate the printing option.

The communicating part may receive a web page including the motion image from the web server, and the image processor may generate the print data to correspond to the web page including the at least one still image.

The image processor may generate the print data to be printed on a printing medium, and the print option is changed when a size of the web page and the at least one still image is larger than a size of the printing medium.

The apparatus may further include an input part to adjust the print option to print an image of at least one of the web page and the at least one still image on a printing medium according to a size of the printing medium and a size of the image of the at least one of the web page and the at least one still image.

The image processor may generate a window to sequentially display the plurality of still images of the motion image, and the at least one still image may be selected from the sequentially displayed plurality of still images of the motion image according to a selection signal.

### BRIEF DESCRIPTION OF THE DRAWINGS

The above and/or other aspects and utilities of the present general inventive concept will become apparent and more readily appreciated from the following description of the exemplary embodiments, taken in conjunction with the accompanying drawings of which:

FIG. 1 is a block diagram illustrating an image processing apparatus according to an exemplary embodiment of the present general inventive concept;

FIG. 2 illustrates an example of printing data of an image processing apparatus according to an exemplary embodiment of the present general inventive concept;

FIG. 3 illustrates another example of printing data of an image processing apparatus according to an exemplary embodiment of the present general inventive concept; and

FIG. 4 is a flowchart illustrating an operation of an image processing apparatus according to an exemplary embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

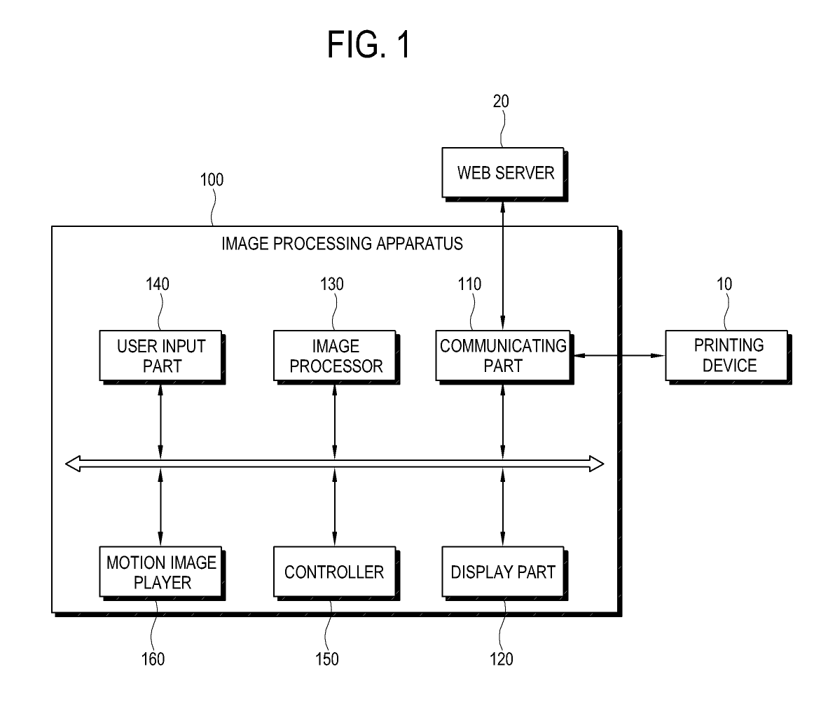

FIG. 1 is a block diagram illustrating an image processing apparatus 100 according to an exemplary embodiment of the present general inventive concept.

The image processing apparatus 100 may include a computer system. The image processing apparatus 100 is a host apparatus to communicate with a printing device 10, such as a printer and a multifunction printer, and to generate printing data to be transmitted to the printing device 10 and to be printed on a printing medium (not illustrated) such as a printing paper.

The image processing apparatus 100 displays at least one web page, and generates the printing data of the displayed web page according to a user's print command.

The web page may include a text, a still image and/or a motion image. The motion image included in the web page may be a motion picture and may include a plurality of still images which may be sequentially displayed. For example, the motion image may include a flash image.

A combination of the text, the still image and/or the motion image can be displayed as the web page. And the motion image may be divided into the plurality of still images, may be represented by the plurality of still images, or may be extracted into the plurality of still images. That is, when the motion image is formed with a sequence of field or frame images as a motion picture, the plurality of still images can be selected from the sequence of the field or frame images of the motion image. When the motion image is displayed in the web page, the field or frame images of the motion image can be displayed in the web page together with the text and/or the still image (another still image). Here, the still image (another still) image may be different from the plurality of still images.

The image processing apparatus 100 generates at least one printing data which is selected by a user among the plurality of still images of the motion image included in the web pages to be printed.

As illustrated in FIG. 1, the image processing apparatus 100 includes a communicator (communicating part) 110, a display part 120, an image processor 130, a user input part 140, a controller 150, and/or a motion image player 160.

The communicator 110 communicates with the printing device 10 through a wired or wireless communication line or network, and transmits the printing data to the printing device 10 by a control of the controller 150. The communicator 110 communicates with the web server 20 through a wired or wireless communication line or network, and receives data of the web page from the web server 20 by a control of the controller 150.

The display part 120 displays the web page by the control of the controller 150.

The image processor 130 generates the printing data of the web page displayed on the display part 120, by the control of the controller 150.

The user input part 140 receives a user's command on the printing data and transmits the command to the controller 150 to control the data of the web page to be displayed, modified, and/or printed.

The controller 150 controls the communicator 110, the display part 120, the image processor 130, the user input part 140, and the motion image player 160.

The controller 150 controls the communicator 110 to receive the web page from a web server 20 according to a user's command inputted by the user input part 140. The controller 150 controls the communicator 110 to transmit the printing data generated by the image processor 130 to the printing device 10.

The controller 150 controls the display part 120 to display the web page transmitted by the communicator 110 thereon. The display part 120 may be disposed in the image processing apparatus 100. However, the display part 120 may be disposed outside the image processing apparatus 100 and may be connected to the image processing part 100 through a wired or wireless connection line or network to receive a signal to display the web page and a modified or changed web page.

The controller 150 controls the image processor 130 to generate the printing data of the web page displayed on the display part 120 according to a user's command inputted by the user input part 140. While generating the printing data, the controller 150 may select at least one of the plurality of still images in the motion image included in the web page according to a user's command, and control the image processor 130 to generate the printing data according to a printing option of the selected still image.

Here, the user's command may be a selection option to define a method of selecting at least one of the plurality of still images from the motion image. The user's command may be previously set or may be a predetermined command.

The printing option may be an option to modify a size of the selected still image, so that the modified size of the selected still image can be printed in a predetermined area of a printing medium. It is possible that the printing option is an option to generate the print data to define the web page and/or the selected still image with respect to print medium.

The controller 150 may display the plurality of still images sequentially, and select at least one of the plurality of displayed still images according to a user's command, so that the selected still image is displayed, modified, or printed together with the web page.

More specifically, the image processing apparatus 100 further includes the motion image player 160 to play a motion image file. The controller 150 receives the motion image file included in the web page displayed on the display part 120 from the web server 20, and controls the motion image player 160 to play the received motion image file.

The controller 150 requests the web server 20 to transmit the motion image file included in the web page, based on information of the web page currently displayed on the display part 120. The information on the web page is stored in a predetermined memory (not illustrated).

For example, the information on the web page may include a uniform resource locator (URL) of the motion image file included in the web page. If the web page is a type of hyper text markup language (HTML), the URL is included in the file of the web page. When the information includes a plurality of URLS corresponding to motion image files, one of the plurality of URLs can be selected to receive the motion image file.

For example, the motion image file received from the web server 20 may include a flash file. In this case, the motion image player 160 may include a flash player. The flash file may be a file including data corresponding to the motion image, and the motion image may be represented by the plurality of still images.

When the motion image file is played as the motion image, the controller 150 may select at lest one still image from the motion image being played. The controller 150 controls the motion image player 160 to display a previous image of the selected still image according to a user's command (i.e., rewind command) or a next image of the selected still image according to a user's command (i.e., fast forward command), while sequentially displaying the plurality of still images of the corresponding motion image.

In this case, the motion image player 160 may display a graphical user interface (GUI) (not illustrated) having items such as rewind, fast forward and still image, on the display part 120. The controller 150 may change a sampling time to play the motion image file, so that the plurality of still images can be selected from the played motion image file according to the sampling time.

The controller 150 determines a form of the printing data according to a user's command corresponding to the print option.

For example, if a user commands to print the overall web page, the printing data corresponds to the web page displayed on the display part 120, and a motion image part of the web page may be replaced with the selected still image.

Then, the controller 150 may control the image processor 130 to generate an image of the web page currently displayed on the display part 120, and to replace the motion image part of the image generated by the information on the web page, with the selected still image.

In another exemplary embodiment, a controller 150 may control an image processor 130 to add a still image according to the selected printing option in a file of the web page currently displayed on the display part 120 and to generate the corresponding printing data.

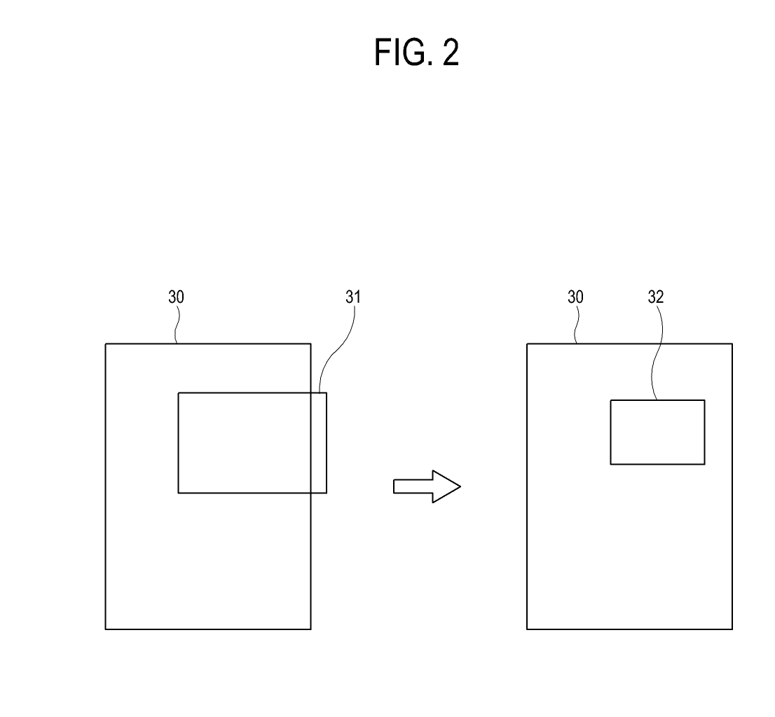

The controller 150 may control the image processor 130 so that a size or position of the selected still image can be changed. As illustrated in FIG. 2, if a size of a still image 31 is too large to be printed on a paper 30, the still image 31 is adjusted, changed, or reduced as the still image 32 to have a size to correspond to a size of the paper 30, so that the still image 32 adjusted from the still image 31 can be printed on the paper 30.

In another exemplary embodiment, the printing data may include only a selected still image. That is, the printing image may be the selected still image itself.

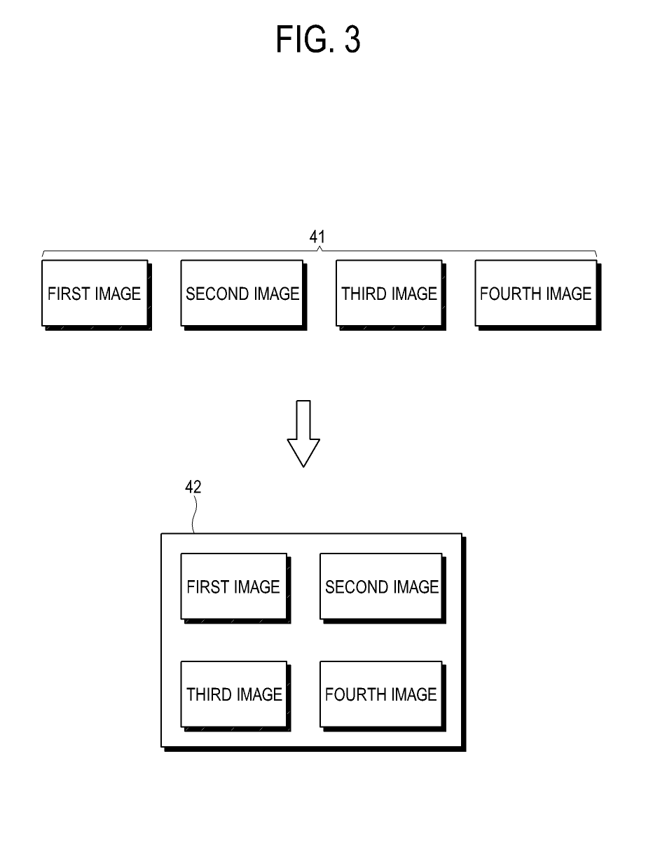

In another exemplary embodiment, the printing data may include a plurality of arranged images which are the same as the selected still image, or the plurality of selected still images that are arranged. As illustrated in FIG. 3, single printing data 42 may be generated based on the first through fourth images 41, i.e., the plurality of selected still images. The size of the still images may be adjusted according to a characteristic of the paper, such as a size of the paper.

In another exemplary embodiment, information on a motion image may be printed instead of the still image. For example, the information on the motion image includes a URL of a motion image file, the number of frames corresponding to respective still images, and other motion image information representing a characteristic of the motion image.

Further, the controller 150 may control the display part 120 to display thereon the image corresponding to the printing data generated according to the printing option of the motion image by a user interface (UI) of the printing device 10.

The image processor 130, the motion image player 160 and the controller 150 according to the exemplary embodiment of the present invention may include a combination of an operating system such as Windows including a web browser, a printer driver and an application program. The application program may be used to play the motion image through an image rendering or generate the printing data.

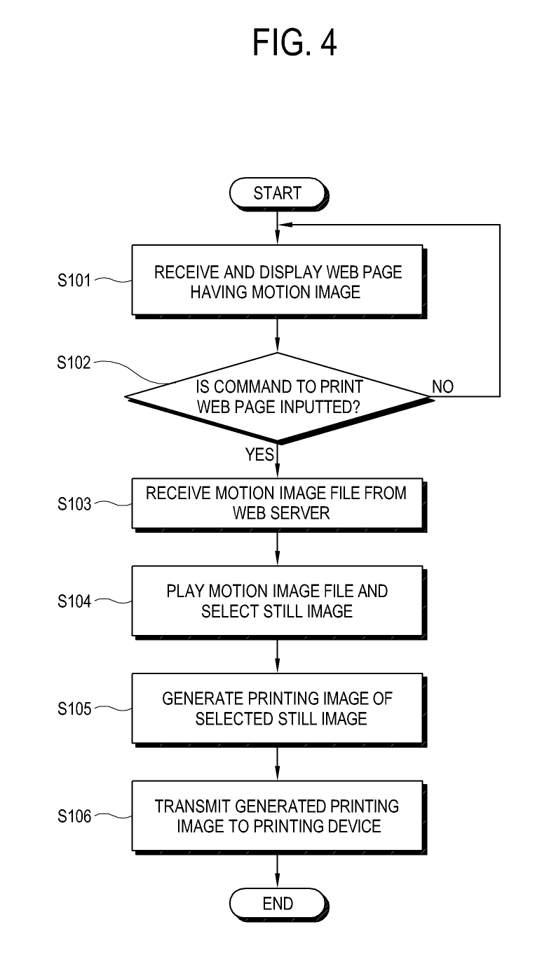

FIG. 4 is a flowchart illustrating an operation of an image processing apparatus according to an exemplary embodiment of the present general inventive concept. Referring to FIGS. 1 and 4, in the image processing apparatus 100, the controller 150 controls the display part 120 to receive the web page having the motion image at operation S101.

Then, the controller 150 determines whether a user commands to print the web page displayed on the display part 120 at operation S102.

If it is determined at the operation of S102 that a user commands to print the web page, the controller 150 controls the communicator 110 to receive the motion image file included in the web page displayed on the display part 120 from the web server 20 at operation S103.

The controller 150 controls the motion image player 160 to play the received motion image file, and selects the printing option of the motion image included in the web page received according to a user's command at operation S104.

Then, the controller 150 controls the image processor 130 to generate the printing data according to the printing option of the selected motion image at operation S105.

The controller 150 may control the communicator 110 to transmit the printing data to the printing device 10 to print the generated printing data at operation S106.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As described above, the present general inventive concept provides an image processing apparatus which prints a desired image of a web page having a motion image and meets a user's demand, and an image processing method thereof.

Also, the present general inventive concept provides an image processing apparatus which prints a desired image of a web page having a motion image, and prevents a user's inconvenience and waste of printing papers, and an image processing method thereof.

Although a few exemplary embodiments of the present general inventive concept have been shown and described, it will be appreciated by those skilled in the art that changes may be made in these exemplary embodiments without departing from the principles and spirit of the general inventive concept, the scope of which is defined in the appended claims and their equivalents.

What is claimed is:

1. An image processing method, comprising:
receiving a web page which has a motion image including a plurality of still images from a web server;
selecting a printing option of the motion image included in the received web page according to a user's command; and
generating printing data according to the selected printing option.

2. The image processing method according to claim 1, wherein the selecting of the printing option of the motion image comprises:
receiving the motion image from the web server; and
playing the received motion image and selecting at least one still image from the motion image being played.

3. The image processing method according to claim 2, wherein the generating of the printing data comprises:
generating the printing data obtained by adding the selected still image to the web page according to the selected printing option.

4. The image processing method according to claim 2, wherein the generating of the printing data comprises:
generating the printing data of the web page; and
modifying the printing data of the web page to replace a motion image part of the generated printing data in the web page with the selected still image.

5. The image processing method according to claim 4, wherein the printing data comprises the selected still image whose size or position is changeable.

6. The image processing method according to claim 4, wherein the printing data comprises at least two selected still images.

7. The image processing method according to claim 4, wherein information on the motion image is printable instead of the still image.

8. The image processing method according to claim 1, further comprising:
displaying an image corresponding to the printing data generated according to the printing option by a user interface of a printing device driver.

9. An image processing apparatus, comprising:
a communicating part which communicates with a web server providing a web page having a motion image including a plurality of still images;
an image processor which generates printing data of the still image; and
a controller which controls the image processor to generate the printing data according to a printing option of the motion image selected by a user's command.

10. The apparatus according to claim 9, further comprising:
a motion image player which plays a motion image file,
wherein the controller controls the motion image player to play the received motion image and select at least one still image from the motion image being played.

11. The apparatus according to claim 10, wherein the controller controls the image processor to generate the printing data obtained by adding the still image to the web page according to the selected printing option.

12. The apparatus according to claim 10, wherein the controller controls the image processor to generate the printing data of the web page and to modify the generated printing data of the generated web page by replacing a motion image part of the generated printing data in the generated web page with the selected still image.

13. The apparatus according to claim 12, wherein the printing data comprises the selected still image whose size or position is changeable.

14. The apparatus according to claim 12, wherein the printing data comprises at least two selected still images.

15. The apparatus according to claim 12, wherein information on the motion image is printable instead of the still image.

16. The apparatus according to claim 9, the controller controls a display part to display an image corresponding to the printing data generated according to the printing option by a user interface of a printing device driver.

17. A computer readable medium to contain computer-readable codes as a program to execute an image processing method in an image processing apparatus, the method comprising:
receiving a web page which has a motion image including a plurality of still images from a web server;
selecting a printing option of the motion image included in the received web page according to a user's command; and
generating printing data according to the selected printing option.

18. An image processing apparatus, comprising:
a communicating part which communicates with a web server to receive a motion image represented by a plurality of still images; and
an image processor which generates print data to correspond to at least one of the plurality of still images according to a printing option of the at least one still image.

19. The apparatus according to claim 18, further comprising:
an input part to select the at least one still image from the plurality of still images, and to generate the printing option.

20. The apparatus according to claim 18, wherein:
the communicating part receives a web page including the motion image from the web server; and
the image processor generates the print data to correspond to the web page including the at least one still image.

21. The apparatus according to claim 18, wherein the image processor generates the print data to be printed on a printing medium, and the print option is changed when a size of the web page and the at least one still image is larger than a size of the printing medium.

22. The apparatus according to claim 18, further comprising:
an input part to adjust the print option to print an image of at least one of the web page and the at least one still image on a printing medium according to a size of the printing medium and a size of the image of the at least one of the web page and the at least one still image.

23. The apparatus according to claim 18, wherein the image processor generates a window to sequentially display the plurality of still images of the motion image, and the at least one still image is selected from the sequentially displayed plurality of still images of the motion image according to a selection signal.
